(19) United States
(12) Patent Application Publication
(10) Pub. No.: US 2021/0267721 A1
(43) Pub. Date: Sep. 2, 2021

(54) ORTHODONTIC APPLIANCE UTILIZING UNILATERAL BITE BLOCK AND EXPANSION SCREW ASSEMBLY

(71) Applicant: Advanced Facialdontics, LLC, St. James, NY (US)

(72) Inventor: Scott A. Simonetti, East Islip, NY (US)

(21) Appl. No.: 17/089,050

(22) Filed: Nov. 4, 2020

Related U.S. Application Data
(60) Provisional application No. 62/983,014, filed on Feb. 28, 2020.

(51) Int. Cl. A61C 7/10; A61C 5/90

(52) U.S. Cl. CPC A61C 7/10; A61C 5/90

(57) ABSTRACT

An orthodontic system including a first appliance configured to removably couple to a maxilla of a mouth of a patient. The first appliance having a first tray and a first expansion screw assembly. The first tray defines a first segment, a second segment, and a third segment. The first tray includes a first bite block extending from one of the first or second segments on a first side of the orthodontic system. The first expansion screw assembly is coupled to the first tray having a first expanding screw and a second expanding screw that are selectively movable to enable the first, second, and third segments of the first tray to move relative to one another.

### CROSS-REFERENCE TO RELATED APPLICATIONS

The present application claims the benefit of U.S. Provisional Patent Application No. 62/983,014, filed on Feb. 28, 2020, the entire contents of which are incorporated by reference herein.

### TECHNICAL FIELD

The present disclosure relates to orthodontic apparatuses, and more particularly, to an orthodontic apparatus having a maxilla appliance and a mandible appliance for improving arch form, developing alveolar bone in the maxilla and mandible of the mouth while straightening teeth in the mouth.

### BACKGROUND

Orthodontic apparatuses, methods, and procedures can be used to correct a variety of oral health issues. Orthodontic cases (braces) have been used to align an individual's teeth to repair abnormalities in the individual's tooth arrangement. Once braces are removed, retainers such as Hawley retainers are fitted for the individual to prevent the individual's teeth from moving after repositioning.

To correct other deficiencies, such as cross-bites, a narrow maxillary or mandibular bone, clenching, grinding, or other oral conditions, apparatuses may be installed temporarily or permanently for varying periods of time to address such conditions, such as palate expanders, mandibular splints and bite plates, or retainers.

### SUMMARY

In accordance with an aspect of this disclosure, an orthodontic apparatus is provided.

In one aspect, the present disclosure provides an orthodontic system including a first appliance configured to removably couple to a maxilla of a mouth of a patient. The first appliance having a first tray and a first expansion screw. The first tray defines a first segment, a second segment, and a third segment and includes a first bite block extending from one of the first or second segments on a first side of the orthodontic system. The first expansion screw assembly is coupled to the first tray and has a first expanding screw and a second expanding screw that are selectively movable to enable the first, second, and third segments of the first tray to move relative to one another.

In aspects, the first appliance may further include at least one t-flap spring disposed along an outer perimeter of the first tray of the first appliance to contact a lingual surface of the teeth.

In aspects, the first bite block may be configured to extend from the first or second segment of the first tray over an occlusal surface of a second premolar and a first molar on the maxilla of the mouth adjacent to the first or second segment.

In aspects, the first appliance may include a Hawley wire and at least one buccal clasp secured to the first tray.

In aspects, the Hawley wire may be secured to the third segment.

In aspects, the at least one buccal clasp may include a first buccal clasp secured to the first segment and a second buccal clasp secured to the second segment.

In aspects, the first tray may include acrylic.

In aspects, movement of the first, second, and third segments may be relative to one another and move the first tray between a retracted position and an expanded position.

In aspects, the first, second, and third segments may be closer to one another in the retracted position and farther from one another in the expanded position.

In aspects, the first expansion screw assembly may be a three-way expansion screw assembly that is centrally disposed between the first, second, and third segments of the first tray.

In aspects, the orthodontic system may further include a second appliance configured to removably couple to a mandible of the mouth of the patient. The second appliance having a second tray and a second expansion screw assembly. The second tray defines a fourth segment and a fifth segment and includes a second bite block extending from one of the fourth or fifth segment on the first side of the orthodontic system. The second expansion screw assembly is coupled to the second tray and has a fourth expanding screw and a fifth expanding screw that are selectively movable to enable the fourth and fifth segments of the second tray to move relative to one another.

In aspects, the second appliance may further include at least one t-flap springs disposed along an outer perimeter of the second tray of the second appliance to contact a lingual surface of the teeth.

In aspects, the second bite block may be configured to extend from the fourth or fifth segment of the second tray adjacent the first bite block over an occlusal surface of a second premolar and a first molar on the mandible of the mouth adjacent to the fourth or fifth segment.

In aspects, the second appliance may include a Hawley wire and, at least one buccal clasps secured to the second tray.

In aspects, the Hawley wire may be secured to the fourth and fifth segment.

In aspects, the at least one buccal clasps may include a third buccal claps secured to the fourth segment and a fourth buccal clasps secured to the fifth segment.

In aspects, the second tray may include acrylic.

In aspects, movement of the fourth and fifth segments may be relative to one another and move the second tray between a retracted position and an expanded position.

In aspects, the fourth and fifth segments may be closer to one another in the retracted position and farther from one another in the expanded position.

In another aspect, the present disclosure provides an orthodontic system including a first appliance configured to removably couple to a maxilla of a mouth of a patient and a second appliance configured to removably couple to a mandible of the mouth of the patient. The first appliance includes a first tray and a second expansion screw assembly. The first tray defines a first segment, a second segment, and a third segment and includes a first bite block extending from one of the first or second segments. The first expansion screw assembly is a three-way expansion screw coupled to the first tray and has a first expanding screw and a second expanding screw that are selectively movable to enable the first, second, and third segments of the first tray to move relative to one another. The second appliance includes a second tray and a second expansion screw assembly. The second tray defines a fourth segment and a fifth segment and includes a second bite block extending from one of the fourth or fifth segments an aligned with the first bite block. The second expansion screw assembly is a two-way expansion screw coupled to the second tray and has a third expanding screw and a fourth expanding screw that are selectively movable to enable the fourth and fifth segments of the second tray.

In aspects, each of the expanding screws may be manually rotatable.

In aspects, rotation of the first expanding screw moves the first segment in an anterior-posterior direction and rotation of the second expanding screw moves the second and third segments in a medial-lateral direction.

Other aspects, features, and advantages will be apparent from the description, the drawings, and the claims that follow.

### BRIEF DESCRIPTION OF THE DRAWINGS

The accompanying drawings, which are incorporated in and constitute a part of this specification, illustrate aspects of this disclosure and, together with a general description of this disclosure given above, and the detailed description given below, serve to explain the principles of this disclosure, wherein:

FIG. 1 is a front view of mouth models with an orthodontic system coupled thereto, the orthodontic system including a maxilla appliance and a mandible appliance in accordance with the principles of this disclosure;

FIG. 2 is a front view of the orthodontic system shown in FIG. 1;

FIG. 3 is a perspective view of the mouth models and orthodontic system of FIG. 1;

FIGS. 4 and 5 are bottom, perspective views illustrating the maxilla appliance of FIG. 1 on a maxilla mouth model of the mouth models of FIG. 1;

FIG. 6 is a top, rear, perspective view of the maxilla appliance;

FIG. 7 is a top, front, perspective view of the maxilla appliance, the maxilla appliance shown in a retracted position;

FIG. 8 is a top, front, perspective view of the maxilla appliance, the maxilla appliance shown in an expanded position;

FIG. 9 is a perspective view of illustrating the mandible appliance of FIG. 1 on a mandible mouth model of the mouth models of FIG. 1;

FIG. 10 is an enlarged, top, perspective view of FIG. 9; and

FIG. 11 is a top, perspective view of the mandible appliance.

### DETAILED DESCRIPTION

Aspects of this disclosure are described in detail with reference to the drawings, in which like reference numerals designate identical or corresponding elements in each of the several views. As used herein, the term “posterior” refers to that portion of structure or user farther from the front of the user's head, while the term “anterior” refers to that portion of structure or user, closer to the front of the user's head. As used herein, the term “clinician” refers to a dentist, orthodontist, hygienist, or other care provider and may include support personnel.

In the following description, well-known functions or constructions are not described in detail to avoid obscuring the present disclosure in unnecessary detail.

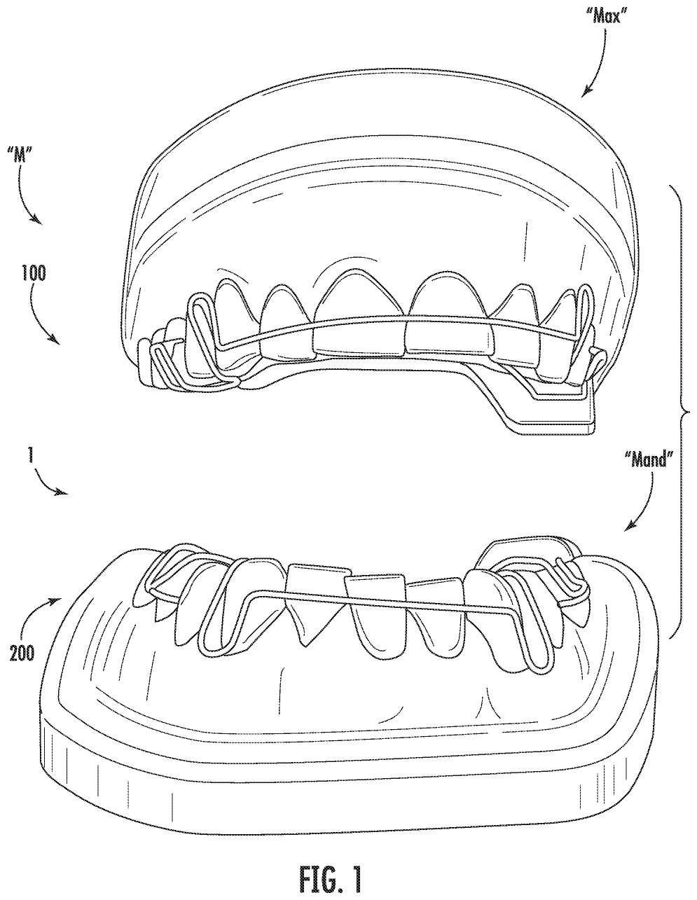

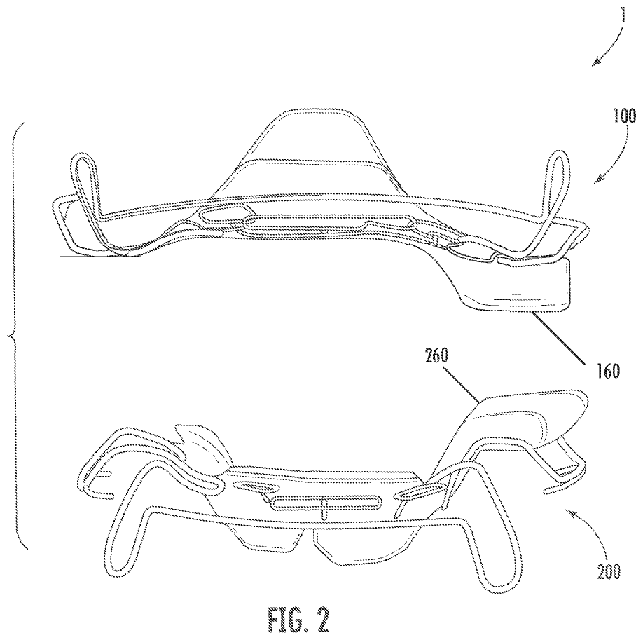

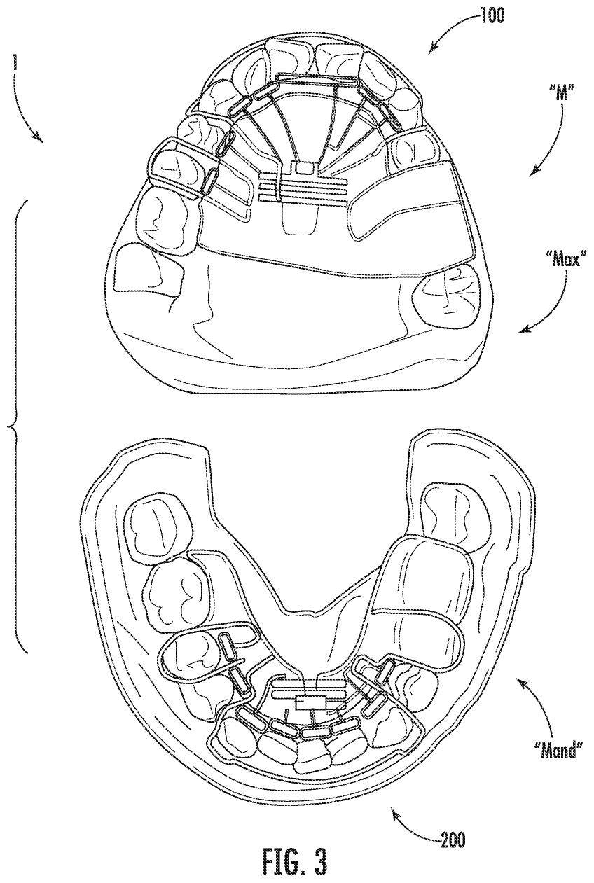

Referring now in specific detail to the drawings, in which like reference numbers identify similar or identical elements, FIGS. 1-3 illustrate an orthodontic apparatus, shown generally as 1. The orthodontic apparatus 1 generally includes a maxilla appliance 100 configured to removably couple to a patient's maxilla and/or a maxilla mouth model “Max” of a mouth model system “M” (e.g., models of a patient's mouth), and a mandible appliance 200 that is configured to removably couple to a patient's mandible and/or a mandible mouth model “Mand” of the mouth model system “M.”

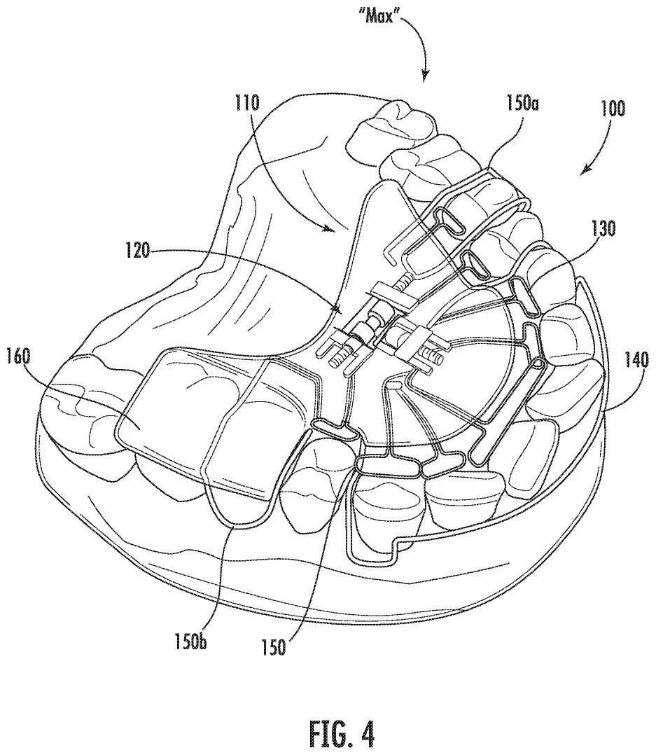

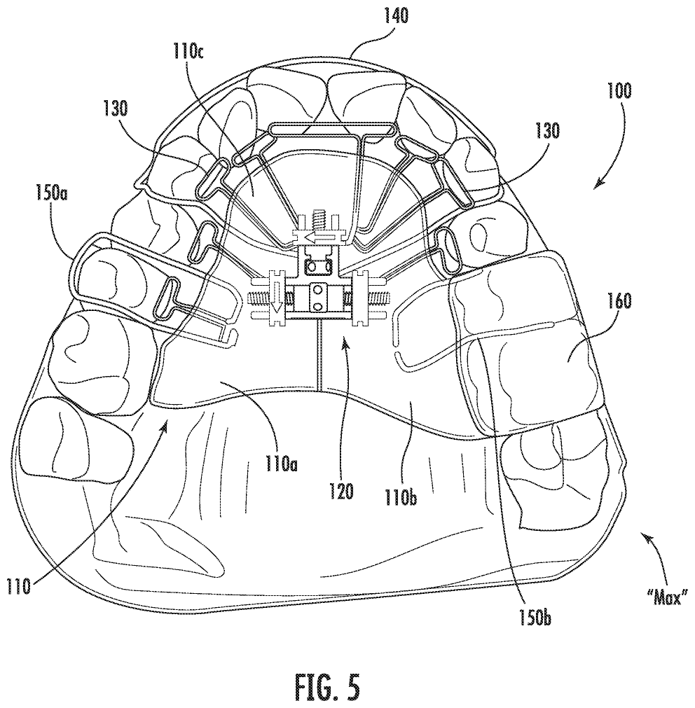

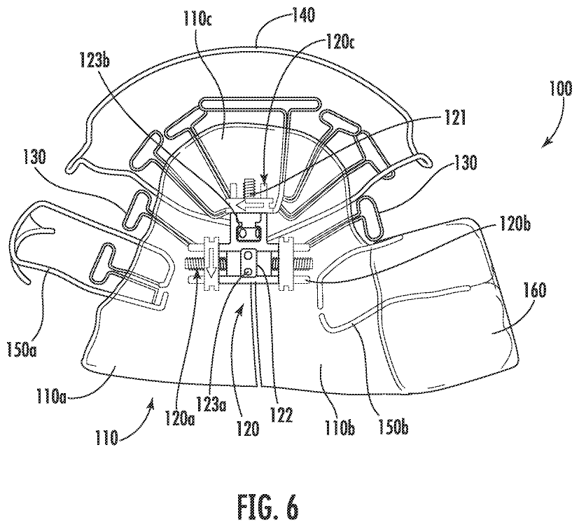

FIGS. 4-6 illustrate the details of the maxilla appliance 100 of the orthodontic apparatus 1. The maxilla appliance 100 includes a tray 110, a maxilla expansion screw assembly 120, one or more t-flap spring(s) 130, a Hawley wire 140, buccal clasp(s) 150a, 150b, and a bite block 160. The tray 110 is configured to be custom modeled to the contours of a palate of a patient and/or a model thereof (e.g., from the mouth model system “M”). The tray 110 may be formed of any suitable material such as, for example, acrylic. The tray 110 is trifurcated and defines three distinct segments 110a, 110b, and 110c. When the tray 110 is supported in a patient's mouth or on the maxilla mouth model of the mouth model system “M,” segment 110a of tray 110 is positioned on a left maxilla quadrant or left side of the maxilla of the patient or the maxilla mouth model “Max,” segment 110b of the tray 110 is positioned on a right maxilla quadrant or right side of the maxilla of the patient or the maxilla mouth model “Max,” and segment 110c is positioned anteriorly of segments 110a and 110b.

The segments 110a, 110b, and 110c are coupled to one another by the maxilla expansion screw assembly 120 and are configured to be positioned in the pre-maxilla region of the maxilla mouth model “Max.” The maxilla expansion screw assembly 120 may be a 3-way sagittal Y-split expansion screw assembly with two independently rotatable screws 121 and 122 disposed transverse to one another and which are each manually rotatable with one or more dental tools such as an Allen wrench to move three (3) expanding section(s) 120a, 120b, and 120c thereof relative to one another by virtue of the expanding section(s) 120a, 120b, and 120c being secured to (e.g., integrally formed with) segment(s) 110a, 110b, and 110c of the tray 110, respectively. In particular, the dental tools (not shown) are insertable within openings 123a, 123b and actuatable to cause screws 121 and 122 to rotate. Rotatable screw 121 imparts translational movement of section 120c, and therefore segment 110c, in the anterior-posterior direction in response to rotation of rotatable screw 121, which is independent of rotation of rotatable screw 122. Rotatable screw 122 imparts translational movement of sections 120a and 120b, and therefore segments 110a and 110b, in the medial-lateral direction in response to rotation of rotatable screw 122 independent of rotation of rotatable screw 121. In this regard, movement of the segment(s) 110a, 110b, and 110c results in lateral arch form expansion along with anterior development of the pre-maxilla region, alveolar bone development in the maxilla and mandible, teeth straightening, as well as improvement in airway tone and airway size and improved daytime breathing.

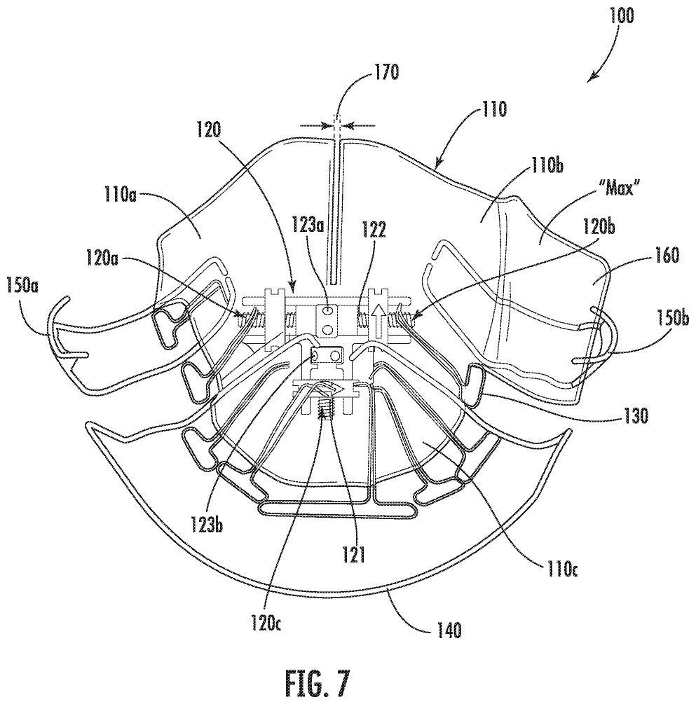

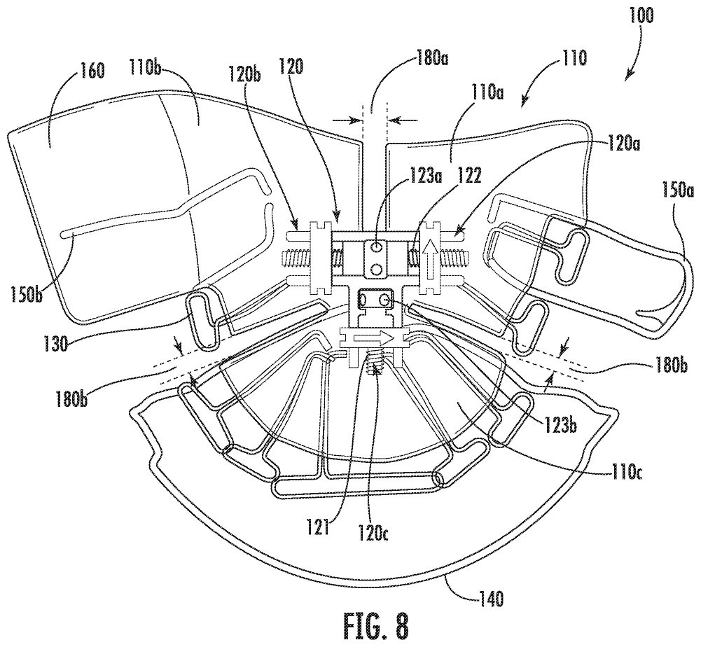

FIGS. 7 and 8 illustrate the tray 110 in a retracted position and an expanded position, respectively. Upon movement of the expanding section(s) 120a and 120b of the maxilla expansion screw assembly 120, segments 110a and 110b of the tray 110 are expanded laterally to expand the space between segments 110a and 110b from the retracted position (e.g., minimum spacing between segments 110a and 110b as indicated by 170) to the expanded position (e.g., maximum spacing between segments 110a and 110b as indicated by 180a). Upon movement of the expanding section 120c of the maxilla expansion screw assembly 120, segment 110c of the tray 110 is expanded anteriorly to expand the spacing of segment 110c relative to segments 110a and 110b (e.g., where maximum spacing of segment 110c relative to segments 110a and 110b is indicated by 180b).

The one or more t-flap springs(s) 130 are integrally formed with the tray 110 and disposed along the outer perimeter thereof to contact a lingual surface of the teeth. The springs 130 are configured to engage inner teeth such as, for example molars, premolars, canine, and incisors. The t-flap spring(s) 130 are further configured to improve arch form of a patient's maxilla while straightening the teeth. The t-flap spring(s) 130 may be configured to engage individual teeth, or more than one tooth at a time.

The maxilla appliance 100 is held in place by the Hawley wire 140 and the buccal clasp(s) 150a, 150b. The bite block 160 extends from tray 110 over an occlusal surface of a second premolar and a first molar on either the left or right side of the maxilla (although shown on the left side) and is configured to impart unilateral mechanical bite forces on one side of the patient's mouth in conjunction with a counterpart bite block extending from the mandible appliance 200 on the same side (e.g., bite blocks are aligned in contacting relation with one another, or in mirrored relation with one another, on the same side of the mouth). The Hawley wire 140 is integrally formed with the segment 110c of the tray 110 and configured to be positioned anteriorly from the canine on the left side of the maxilla of a patient to the canine on the right side of the maxilla of a patient, whereby the ends of the Hawley wire 140 are looped around the canines on the left and right side of the maxilla. The buccal clasp(s) 150a, 150b are integrally formed with the segment 110a and 110b of tray 110, respectively, and configured to support, stabilize, and retain the second premolar on the left and right side of the maxilla of a patient. Based on the position of the bite block 160, either the buccal clasp 150a or 150b may be integrally formed with the bite block 160.

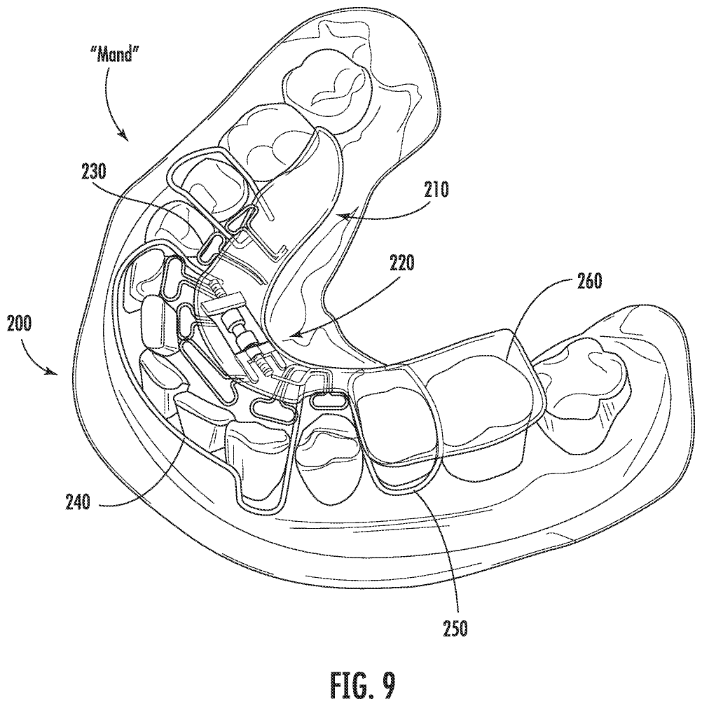

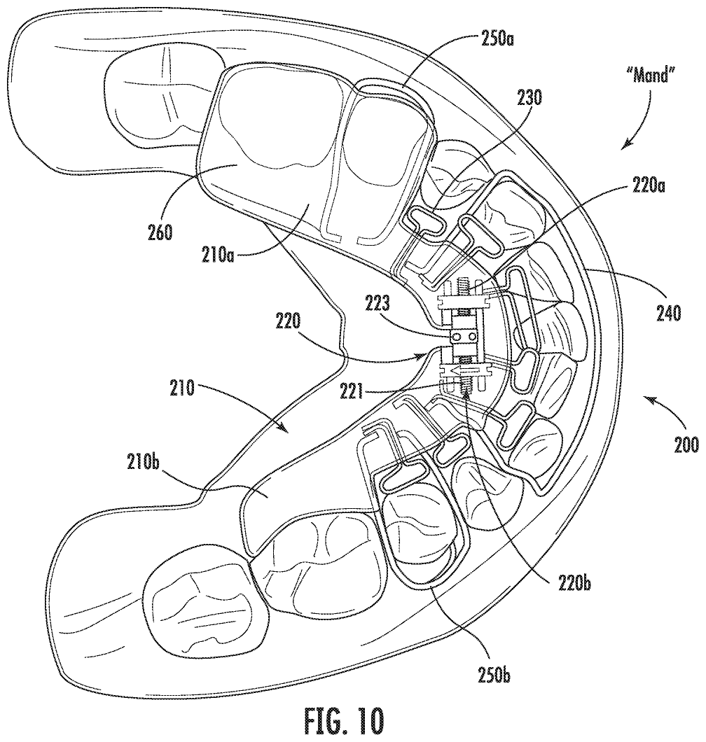

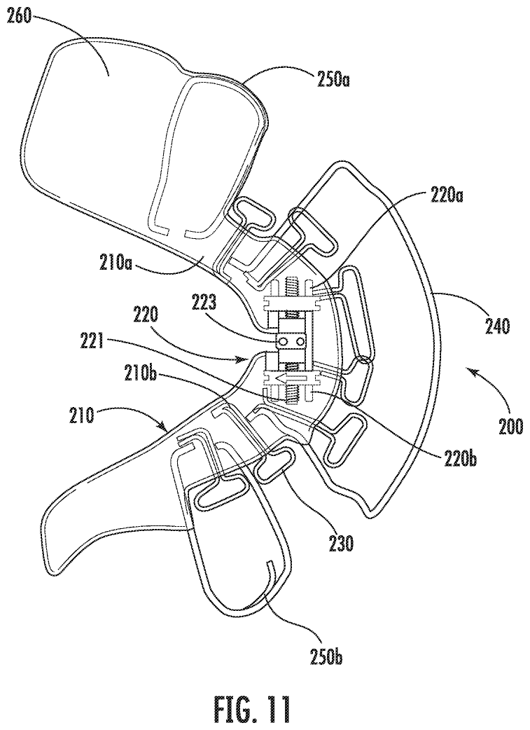

FIGS. 9-11 illustrate the details of the mandible appliance 200. The mandible appliance 200 includes a tray 210, a mandible expansion screw assembly 220, one or more t-flap spring(s) 230, a Hawley wire 240, buccal clasp(s) 250a, 250b, and a bite block 260. The tray 210 is configured to be custom modeled to the contours of a floor of a patient's mouth or of the mouth model system “M” terminating at a beginning of the sublingual gland. The tray 210 may be formed of any suitable material such as, for example, acrylic. The tray 210 is bifurcated and defines two distinct segments 210a, 210b. When the tray 210 is worn by a patient, segment 210a of tray 210 is positioned on a left mandible quadrant or left side of the mandible and segment 210b of the tray 210 is positioned on a right mandible quadrant or right side of the mandible.

The segments 210a, 210b are coupled to one another by the mandible expansion screw assembly 220 positioned in a pre-mandible region of a mandible of a patient or a mandible mouth model “Mand.” The mandible expansion screw assembly 220 may be a lateral expansion screw with a rotatable screw 221 which is manually rotatable with one or more dental tools such as an Allen wrench to move two (2) expanding section(s) 220a, 220b thereof relative to one another by virtue of the expanding section(s) 220a, 220b being secured to (e.g., integrally formed with) segment(s) 210a, 210b of the tray 210, respectively. In particular, the dental tools (not shown) are insertable within opening 223 and actuatable to cause screw 221 to rotate. Rotatable screw 221 imparts translational movement of sections 220a and 220b, and therefore segments 210a and 210b, in the medial-lateral direction in response to rotation of rotatable screw 221. In this regard, movement of the expanding section(s) 220a, 220b results in lateral arch form expansion along with anterior development of the pre-mandible region, alveolar bone development in the maxilla and mandible, teeth straightening, as well as improvement in airway tone and airway size and improved daytime breathing.

The one or more t-flap springs(s) 230 are integrally formed with the tray 210 and disposed along the outer perimeter thereof. The t-flap springs 230 are configured to engage teeth on an inner portion of the patient's mouth or of a mouth model system “M,” such as, for example molars, premolars, canine, and incisors. The t-flap spring(s) 230 are further configured to improve arch form of the mandible of a patient while straightening the teeth. The t-flap spring(s) 130 may be configured to engage individual teeth, or more than one tooth at a time. The mandible appliance 200 is held in place by the Hawley wire 240, the buccal clasp(s) 250a, 250b, and the bite block 260. The tray 210 may further include the bite block 260 that extends over an occlusal surface of a second premolar and a first molar on either the left or right side of the mandible of the patient or the mandible mouth model “Mand.” As noted above, the bite blocks are positioned to align with one another to enable lateral arch form expansion along with anterior development of the pre-maxilla region, alveolar bone development in the maxilla and mandible, teeth straightening, as well as improvement in airway tone and airway size and improved daytime breathing. The unilateral positioning of the disclosed bite blocks relative to one another also helps to retain the appliances 100, 200 in the patient's mouth. The bite block 260 is configured to receive force applied by the occlusal surface of the maxilla of the patient and focus the received force to a subset of the portion of the mandible of the patient and the maxilla of the patient in contact with the bite block 260. The concentration of force applied causes the patient to, consciously or sub-consciously, reduce and/or eliminate the application of force to the bite block 260. As a result, the bite block 260 reduces stress applied to the patient's teeth further reducing contact points between the mandible of the patient and the maxilla of the patient. Further benefits for the bite block and occlusal surface are described in, for example, U.S. Pat. No. 10,639,187, entitled “Apparatus and Method for Reducing Bruxism and Occlusal Forces,” and U.S. Patent Application Publication No. 2018/0071130, entitled “Method for Stimulation of Endogenous Craniofacial Osteogenesis via Stem Cell Activation,” the entire contents of each of which are hereby incorporated by reference herein.

The Hawley wire 140 is integrally formed with segments 210a and 210b and configured to be positioned anteriorly from the canine on the left side of the mandible of a patient or of the mandible mouth model “Mand” to the canine on the right side of the mandible of a patient or the mandible mouth model “Mand,” whereby the ends of the Hawley wire 240 are looped around the canines on the left and right side of the mandible of a patient or the mandible mouth model “Mand.” The buccal clasp(s) 250a, 250b are integrally formed with the segment 210a and 210b of tray 210, respectively, and configured to support, stabilize, and retain the second premolar on the left and right side of the mandible of a patient or the mandible mouth model “Mand.” Based on the position of the bite block 260, either the buccal clasp 250a or 250b are further formed with the bite block 260.

Based on the nature of current and pre-existing dental work of a user, placement of different elements of the maxilla appliance 100 and mandible 200, such as, for example, t-flap spring(s) 130, 230, buccal clasp(s) 150a, 150b, 250a, and 250b, Hawley wire 140, 240 are adjusted, for example, to conform to the mouth models “M” of each user.

Both the maxilla appliance 100 and the mandible appliance 200 are configured to provide mechanotherapy by sending light intermittent force to teeth in contact with the t-flap springs 130 and/or 230 when swallowing and/or biting into the bite block 160 or 260, thereby remodeling the dental arches, while straightening the teeth. Accordingly, providing more room for the tongue and decompression of a temporomandibular joint (TMJ) capsule, and additionally, allowing for improved jaw function and sleep quality (see for example, U.S. Pat. No. 10,639,187, referenced hereinabove). The disclosed devices can also improve airway tone and airway size which leads to improved daytime breathing as noted above.

The bite blocks of this disclosure may have heights between about 1 mm to about 7 mm. The bite blocks that oppose on another may be the same or substantially the same height as one another. The bite blocks are configured to be reducible by a dentist with standard dental handpieces such as an acrylic burr on a low-speed or a diamond on a high speed dental handpiece.

One or more of the disclosed components may be secured to one another via any suitable technique such as welding, crimping, gluing, fastening, or the like.

Persons skilled in the art will understand that the structures and methods specifically described herein and shown in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, the elements and features shown or described in connection with certain aspects may be combined with the elements and features of certain other aspects without departing from the scope of this disclosure, and that such modifications and variations are also included within the scope of this disclosure. Accordingly, the subject matter of this disclosure is not limited by what has been particularly shown and described.

1. An orthodontic system, the system comprising:
a first appliance configured to removably couple to a maxilla of a mouth of a patient, the first appliance including:
a first tray defining a first segment, a second segment, and a third segment that have a first thickness, the first tray including a first unilateral bite block extending from one of the first or second segments on a first side of the orthodontic system laterally over only a lingual side surface and an occlusal surface of a tooth of the patient, the first unilateral bite block including:
an upper surface that is configured to extend over a first occlusal plane defined by the tooth of the patient; and
a lower surface separated from the upper surface by a second thickness between the upper and lower surfaces, the second thickness being larger than the first thickness and arranged to impart unilateral bite forces on the mouth of the patient; and
a first expansion screw assembly coupled to the first tray, the first expansion screw assembly having a first expanding screw and a second expanding screw that are selectively movable to enable the first, second, and third segments of the first tray to move relative to one another, the first and second expanding screws disposed in transverse relation to each other in a single screw housing.

2. The orthodontic system according to claim 1, wherein the first appliance further includes at least one t-flap spring disposed along an outer perimeter of the first tray of the first appliance to contact a lingual surface of the teeth.

3. The orthodontic system according to claim 1, wherein the first unilateral bite block is configured to extend from the first or second segment of the first tray over an occlusal surface of a second premolar and a first molar on the maxilla of the mouth adjacent to the first or second segment.

4. The orthodontic system according to claim 1, wherein the first appliance includes a Hawley wire and at least one buccal clasp secured to the first tray.

5. The orthodontic system according to claim 4, wherein the Hawley wire is secured to the third segment.

6. The orthodontic system according to claim 5, wherein the at least one buccal clasp includes a first buccal clasp secured to the first segment and a second buccal clasp secured to the second segment.

7. The orthodontic system according to claim 1, wherein the first tray includes acrylic.

8. The orthodontic system according to claim 1, wherein movement of the first, second, and third segments relative to one another moves the first tray between a retracted position and an expanded position, and wherein the first, second, and third segments are closer to one another in the retracted position and farther from one another in the expanded position.

9. (canceled)

10. The orthodontic system according to claim 1, wherein the single screw housing is a three-way T-shaped expansion screw housing that is centrally disposed between the first, second, and third segments of the first tray; and
wherein the first expanding screw is configured to impart translational movement of the third segment in an anterior-posterior direction, and the second expanding screw imparts translational movement of the first or second segments in a medial-lateral direction.

11. The orthodontic system according to claim 1, wherein the first unilateral bite block further includes a first posterior side surface, a first anterior side surface, a first buccal side surface, and a first lingual side surface that extend from the upper surface of the first bite block to the lower surface of the first bite block, and wherein the orthodontic system further comprises:
a second appliance configured to removably couple to a mandible of the mouth of the patient, the second appliance including:
a second tray defining a fourth segment and a fifth segment that have a third thickness, the second tray including a second unilateral bite block extending from one of the fourth or fifth segments on the first side of the orthodontic system, the second unilateral bite block including:
a lower surface that is configured to extend over a second occlusal plane defined by a tooth of the mandible of the mouth of the patient;
an upper surface separated from the lower surface by a fourth thickness between the upper and lower surfaces of the second unilateral bite block, the fourth thickness being larger than the third thickness and arranged to impart unilateral bite forces on the mouth of the patient; and
a second posterior side surface, a second anterior side surface, a second buccal side surface, and a second lingual side surface that extend from the upper surface of the second unilateral bite block to the lower surface of the second unilateral bite block; and
a second expansion screw assembly coupled to the second tray, the second expansion screw assembly having a third expanding screw and a fourth expanding screw that are selectively movable to enable the fourth and fifth segments of the second tray to move relative to one another.

12. The orthodontic system according to claim 11, wherein the second appliance further includes at least one t-flap springs disposed along an outer perimeter of the second tray of the second appliance to contact a lingual surface of the teeth.

13. The orthodontic system according to claim 11, wherein the second unilateral bite block is configured to extend from the fourth or fifth segment of the second tray adjacent the first unilateral bite block over an occlusal surface of a second premolar and a first molar on the mandible of the mouth adjacent to the fourth or fifth segment, and wherein the first unilateral bite block and second unilateral bite block are aligned in contacting relation with one another.

14. The orthodontic system according to claim 11, wherein the second appliance includes a Hawley wire secured to at least one of the fourth or fifth segments and, at least one buccal clasp secured to the second tray.

15. (canceled)

16. The orthodontic system according to claim 14, wherein the at least one buccal clasp includes a third buccal clasp secured to the fourth segment and a fourth buccal clasp secured to the fifth segment.

17. The orthodontic system according to claim 11, wherein the second tray includes acrylic.

18. The orthodontic system according to claim 11, wherein movement of the fourth and fifth segments relative to one another moves the second tray between a retracted position and an expanded position, and wherein the fourth and fifth segments are closer to one another in the retracted position and farther from one another in the expanded position.

19. (canceled)

20. An orthodontic system, the system comprising:
a first appliance configured to removably couple to a maxilla of a mouth of a patient, the first appliance including:
a first tray defining a first segment, a second segment, and a third segment, the first tray including a first unilateral bite block extending from one of the first or second segments laterally over only a lingual side surface and an occlusal surface of a tooth of the maxilla of the mouth of the patient, the first unilateral bite block including:
an upper surface that is configured to extend over a first occlusal plane defined by the tooth of the maxilla of the mouth of the patient;
a lower surface separated from the upper surface; and
a first posterior side surface, a first anterior side surface, a first buccal side surface, and a first lingual side surface that extend from the upper surface of the first unilateral bite block to the lower surface of the first unilateral bite block; and
a first expansion screw assembly coupled to the first tray, the first expansion screw assembly being a three-way expansion screw and having a first expanding screw and a second expanding screw that are selectively movable to enable the first, second, and third segments of the first tray to move relative to one another; and
a second appliance configured to removably couple to a mandible of the mouth of the patient, the second appliance including:
a second tray defining a fourth segment and a fifth segment, the second tray including a second unilateral bite block extending from one of the fourth or fifth segments laterally over only a lingual side surface and an occlusal surface of a tooth of the mandible of the mouth of the patient and aligned with the first unilateral bite block, the second unilateral bite block including:
a lower surface that is configured to extend over a second occlusal plane defined by the tooth of the mandible of the mouth of the patient;
an upper surface separated from the lower surface; and
a second posterior side surface, a second anterior side surface, a second buccal side surface, and a second lingual side surface that extend from the upper surface of the second unilateral bite block to the lower surface of the second unilateral bite block; and
a second expansion screw assembly coupled to the second tray, the second expansion screw assembly being a two-way expansion screw having a third expanding screw and a fourth expanding screw that are selectively movable to enable the fourth and fifth segments of the second tray to move relative to one another.

21. (canceled)

22. The orthodontic system of claim 20, wherein rotation of the first expanding screw moves the first segment in an anterior-posterior direction and wherein rotation of the second expanding screw move the second and third segments in a medial-lateral direction.

23. The orthodontic system according to claim 1, wherein the first unilateral bite block further includes a first posterior side surface, a first anterior side surface, a first buccal side surface, and a first lingual side surface that extend from the upper surface to the lower surface.

24. The orthodontic system of claim 23, wherein the first posterior and first anterior side surfaces are configured to extend at least as wide as an occlusal surface of the tooth of the patient.

25. The orthodontic system of claim 23, wherein the first lingual side surface extends from the first or second segment to the upper surface of the first unilateral bite block.

26. The orthodontic system of claim 11, wherein the second and fourth thicknesses are between about one millimeter (mm) and about seven mm.
